(19) United States
(12) Patent Application Publication
(10) Pub. No.: US 2023/0196939 A1
(43) Pub. Date: Jun. 22, 2023

(54) SYSTEM AND METHOD FOR SUPPORTING STUDY BASED ON PERSONALITY TYPE

(71) Applicant: WOONGJIN THINKBIG CO., LTD., Paju-si (KR)

(72) Inventors: Samrak CHOI, Paju-si (KR); Uiyoung KIM, Paju-si (KR); Uijin SON, Paju-si (KR)

(73) Assignee: WOONGJIN THINKBIG CO., LTD., Paju-si (KR)

(21) Appl. No.: 18/086,533

(22) Filed: Dec. 21, 2022

(30) Foreign Application Priority Data
Dec. 21, 2021 (KR) 10-2021-0183336

(51) Int. Cl. G09B 7/04

(52) U.S. Cl. CPC G09B 7/04

(57) ABSTRACT

This disclosure presents a system and a method for supporting study based on personality type which set a personality type of a learner and provide a different type of wrong answer note according to the personality type to strengthen the learner's self-directedness and satisfy the learner's own personalization bodily sensation rate. The learning support server of the presented system for supporting study based on personality type detects the learner's personality type, sets the learner's personality type when the detected learner's personality type is ‘Null’, transmits learning information to a learning terminal when the personality type is set, and provides a wrong answer note generated in a form corresponding to the learner's personality type in response to a wrong answer note provision request of the learning terminal.

### TECHNICAL FIELD

The present disclosure relates to a system and a method for supporting study based on personality type.

### BACKGROUND ART

In the process of learning, learners construct wrong answer notes using the questions which the learners incorrectly answered, and learn them repeatedly. Wrong answer notes may be classified into a traditional manner, a digital manner, and a mixed manner.

The traditional manner of wrong answer note provides an actual note having a layout for writing wrong answers, and the learner directly writes and manages wrong answers in the actual note. However, in the general wrong answer note manner, since the learner writes down the wrong answers directly, there is a problem in that a lot of time and efforts are consumed.

As the importance of on-line learning using digital devices increases, wrong answer notes are being constructed digitally. The digital manner of wrong answer notes provides a method for managing wrong answers by utilizing data related to learners' learning or data related to questions. However, the digital type of wrong answer notes has a problem in that it is difficult to manage the psychological part that motivates various learners to learn.

Recently, in order to address the problems of the traditional manner and the digital manner, a mixed-manner wrong answer note that combines the traditional manner (i.e., off-line) and the digital manner has been developed. In the mixed-manner wrong answer note, actual papers such as question papers and test papers are scanned through the camera of the digital device and transmitted to the digital screen, and then the wrong answers are managed. However, the mixed-manner wrong answer notes have a problem in that the recognition rate is lowered depending on the performance of the optical technology and device.

Recently, wrong answer notes are developing in the direction of personalization by identifying the correlation between a learner and questions and classifying the causes of wrong answers according to the correlation while utilizing the learner's learning-related data (e.g., bodily sensation difficulty, learning habit, correct answer rate, etc.) and/or question-related data (e.g., question format, difficulty, subject, solution, etc.).

In these days, however, as the need for non-face-to-face lectures has increased due to environmental factors such as corona virus disease 19 (COVID-19), it has become difficult for learners to face-to-face with teachers who have managed learning motivation and psychological interaction of learners beyond knowledge transfer.

In particular, as for wrong answer notes, individual self-directedness is important, and thus more suitable information can be provided only when individual characteristics are more closely identified.

With the recent development of personalization technology, the primary aspect of identifying learners' learning habits or the causes of wrong answers is being applied to services, but there are limits. For example, it fails to consider the psychological aspect of learning of various learners, such as learners who are highly motivated by praise, learners who are afraid of failure, and the like, and only the boredom of learning is repeated by providing learners with all the wrong answers.

In order to effectively respond to this, it is necessary to study in the direction of categorizing various learners' psychological factors and efficiently stimulating learners' self-directedness based on this.

It should be appreciated that the description provided in the background art is intended to help readers understand the background of the disclosure, and may include matters that are not publicly disclosed in the prior art.

### DOCUMENT OF RELATED ART

(Patent Document) Korean Patent Publication No. 10-2020-0088077 (Title: A METHOD FOR PROVIDING LEARNING SERVICES BASED ON INFORMATION IN COLLECTIONS OF MISSED QUESTIONS AND AN APPARATUS USING IT)

### DISCLOSURE

### Technical Problem

The present disclosure has been proposed in view of the above circumstances, and is to provide a system and a method for supporting study based on personality type which set a personality type of a learner and provide a different type of wrong answer note according to the personality type to strengthen the learner's self-directedness and satisfy the learner's own personalization bodily sensation rate.

In other words, the present disclosure is to provide a system and a method for supporting study based on personality type which are configured to set the personality type of the learner by identifying the personality elements of the learner through a personality test using animation, and to provide and manage wrong answer notes through an appropriate method for each personality type.

### Technical Solution

In order to achieve the above objectives, a system for supporting study based on personality type according to the present disclosure includes a learning support server connected with a learning terminal through a network, wherein the learning support server includes: a control module which outputs a personality type query including a learner identifier of the learning terminal, which, if personality type information received as a response to the personality type query is ‘Null’, outputs a personality type setting request including the learner identifier, which, when a personality type setting completion message is received in response to the personality type setting request, outputs a learning start request including the learner identifier, and which outputs a wrong answer note provision request including the learner identifier in response to a wrong answer note request from the learning terminal; a personality diagnosis module which transmits a personality type diagnosis start request to the learning terminal in response to a personality type setting request of the control module, which calculates a propensity value for each personality type based on question and response information of the learning terminal, that is a response to the personality type diagnosis start request, and which sets the personality type of the learner based on the propensity value for each personality type; a learning support module which outputs a learning information detection query including the learner identifier in response to a learning start request from the control module, which transmits learning information included in a learning information detection completion message, that is a response to the learning information detection query, to the learning terminal, and which outputs a wrong answer storage request query including a question code of a question determined to be a wrong answer and the learner identifier in response to a learning confirmation request of the learning terminal; and a wrong answer note generation module which outputs a wrong answer detection request query and a personality type detection request query including the learner identifier in response to a wrong answer note provision request of the control module, which detects a personality type from a personality type detection completion message that is a response to the personality type detection request query, which detects wrong answer information from a wrong answer detection completion message that is a response to the wrong answer detection request query, and which transmits to the learning terminal a wrong answer note in which the wrong answer information is inserted into a wrong answer note form corresponding to the personality type.

In order to achieve the above objectives, a method for supporting study based on personality type according to the present disclosure is a method for supporting study based on personality type performed by a system for supporting study based on personality type connected with a learning terminal through a network, the method for supporting study based on personality type including: determining whether to approve a login of a learner accessing through the learning terminal; detecting a personality type of the learner if it is determined that the login is approved in the determining; setting a personality type of the learner if the personality type of the learner is ‘Null’ in the detecting; transmitting learning information to the learning terminal when the personality type of the learner is detected in the detecting or the personality type is set in the setting the personality type; and transmitting a wrong answer note generated in a form corresponding to the personality type of the learner to the learning terminal when receiving a wrong answer note provision request from the learning terminal after the transmitting the learning information.

### Advantageous Effects

According to the present disclosure, there is an effect that the system and the method for supporting study based on personality type according to the personality type sets the personality type of the learner, and provides different types of wrong answer notes according to the personality type, thereby stimulating the learner's curiosity and learning motivation to induce them to focus on learning.

Additionally, the system and the method for supporting study based on personality type according to the personality type have an effect of increasing the learner's learning achievement and learning efficiency by providing the learner with an appropriate form of wrong answer note.

Also, the system and the method for supporting study based on personality type according to the personality type have an effect of increasing the learning satisfaction since the learner can proceed with the learning in a desired state by providing the learner with an appropriate form of wrong answer note.

Moreover, when learners manage their own wrong answers in non-face-to-face classes, the system and the method for supporting study based on personality type according to the personality type has the effect of increasing the personalized bodily sensation rate and increasing self-directedness when managing wrong answers, without being limited to the learning aspect.

### DESCRIPTION OF DRAWINGS

FIG. 1 is a diagram for explaining the configuration of a system for supporting study based on personality type according to an embodiment of the present disclosure.

FIG. 2 is a diagram for explaining the learner information database of FIG. 1.

FIG. 3 is a diagram for explaining the learning information database of FIG. 1.

FIG. 4 is a diagram for explaining the wrong answer management database of FIG. 1.

FIG. 5 is a diagram for explaining the configuration of the learning support server of FIG. 1.

FIGS. 6 and 7 are diagrams for explaining the personality diagnosis module of FIG. 5.

FIG. 8 is a diagram for explaining an example of a wrong answer note provided to an extroversion learner by the wrong answer note generation module of FIG. 5.

FIG. 9 is a diagram for explaining an example of a wrong answer note provided to an openness learner by the wrong answer note generation module of FIG. 5.

FIG. 10 is a view for explaining an example of a wrong answer note provided to an attraction (agreeableness) learner by the wrong answer note generation module of FIG. 5.

FIG. 11 is a diagram for explaining an example of a wrong answer note provided to a conscientious learner by the wrong answer note generation module of FIG. 5.

FIG. 12 is a diagram for explaining an example of a wrong answer note provided to a neuroticism learner by the wrong answer note generation module of FIG. 5.

FIG. 13 is a flowchart for explaining a method for supporting study based on personality type according to an embodiment of the present disclosure.

FIG. 14 is a flowchart for explaining the log-in step of FIG. 13.

FIG. 15 is a flowchart for explaining the personality type detection step of FIG. 13.

FIG. 16 is a flowchart for explaining the personality type setting step of FIG. 13;

FIGS. 17 and 18 are flowcharts for explaining the learning information provision step of FIG. 13.

FIG. 19 is a flowchart for explaining the wrong answer note provision step in FIG. 13.

### MODE FOR INVENTION

Hereinafter, preferred embodiments of this disclosure will be described in detail with reference to the accompanying drawings.

Examples are provided to explain the present disclosure more fully to those of ordinary skill in the art, and the following examples may be modified into various other forms, and the scope of the present disclosure is not limited to the following examples. Rather, these examples are provided to make this disclosure more thorough and complete, and to fully convey the technical idea of the disclosure.

The terms used herein are used to describe specific embodiments and should not be construed as limiting the present disclosure. Also, in this specification, the use of the singular form term may include its corresponding plural objects, unless the context clearly indicates otherwise.

In the description of the embodiments, each layer (film), region, pattern or structures may be described as being formed “on” or “under” the substrate, each layer (film), region, pad or pattern, and it should be noted that such expression includes both being formed “directly” and “indirectly (or through another layer)” on and under it. Additionally, in principle, the reference for the top or bottom of each layer is based on the drawing.

The drawings are only for understanding the technical idea of the present disclosure, and should not be construed as limiting the scope of the present disclosure by the drawings. In addition, the relative thickness, length, or relative size in the drawings may be exaggerated for convenience and clarity of description.

The system for supporting study based on personality type according to an embodiment of the present disclosure sets the personality type of the learner, and provides different types of wrong answer notes according to the personality type. In other words, the system for supporting study based on personality type sets the personality type of the learner by identifying the personality elements of the learner through a personality test using animation, and provides wrong answer notes through an appropriate method for each personality type. Through this, the system for supporting study based on personality type reinforces learner's self-directedness, and satisfies the learner's personalization bodily sensation rate.

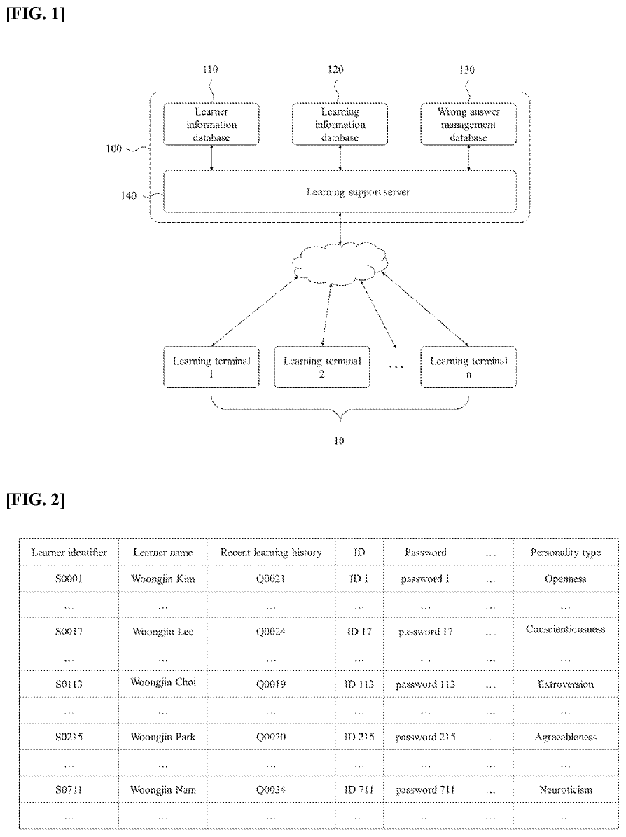

Referring to FIG. 1, the system for supporting study based on personality type 100 includes a learner information database 110, a learning information database 120, a wrong answer management database 130, and a learning support server 140.

The learner information database 110 stores learner's learning history and learner information using the system for supporting study based on personality type 100. As an example, referring to FIG. 2, the learner information database 110 stores a learner identifier, which is a unique identifier given to the learner, a learner name, which is the learner name, a recent learning history, which is the latest learning history of the learner, an ID and a password for using the system for supporting study based on personality type 100, a personality type, which is the learner's personality, and the like, while associating them with each other.

The learner information database 110 detects an ID from the learner authentication query of the control module 143 in response to the learner authentication query. The learner information database 110 detects a learner identifier and password associated with the detected ID. The learner information database 110 generates authentication information including the learner identifier and password detected in response to the learner authentication query, and transmits it to the control module 143.

The learner information database 110 detects the learner identifier from the personality type query of the control module 143 in response to the personality type query. The learner information database 110 detects a personality type associated with the detected learner identifier. The learner information database 110 generates personality type information including the detected personality type in response to the personality type query, and transmits it to the control module 143. At this time, if there is no personality type associated with the learner identifier, the learner information database 110 generates personality type information including ‘Null’ and transmits it to the control module 143.

The learner information database 110 detects the learner identifier and personality type from the personality type storage request query of the personality diagnosis module 145 in response to the personality type storage request query. The learner information database 110 detects learner information having the same learner identifier as the detected learner identifier from among pre-stored learner information. The learner information database 110 stores the personality type detected from the personality type storage request query as the personality type of the detected learner information. After completing the storage of the personality type, the learner information database 110 generates a personality type setting completion message and transmits it to the control module 143.

The learner information database 110 detects the learner identifier and question code from the learning history update request query of the learning support module 147 in response to the learning history update request query. The learner information database 110 detects learner information having the same learner identifier as the detected learner identifier from among pre-stored learner information. The learner information database 110 updates the latest learning history of the detected learner information with the question code detected from the learning history update request query. After updating the learning history, the learner information database 110 generates a learning history update completion message and transmits it to the learning support module 147.

The learner information database 110 detects the learner identifier from the personality type detection request query in response to the personality type detection request query of the wrong answer note generation module 149. The learner information database 110 detects learner information having the same learner identifier as the detected learner identifier from among pre-stored learner information. The learner information database 110 detects the personality type of the detected learner information. The learner information database 110 generates a personality type detection completion message including the detected personality type, and transmits it to the wrong answer note generation module 149.

The learning information database 120 stores learning information provided to learners by the system for supporting study based on personality type 100. As an example, referring to FIG. 3, the learning information database 120 stores a question code, which is a unique identifier given to the question provided to the learner, a question that is a question to be provided to the learner, a learning unit that is a unit to which the question belongs, a similar question code, which is the question code of the question similar to the question, and the like, while associating them with each other.

The learning information database 120 detects a learner identifier from the learning information detection query in response to the learning information detection query of the learning support module 147. The learning information database 120 detects a recent learning history corresponding to the detected learner identifier from the learner information database 110. The learning information database 120 detects learning information including the question code that is the next sequence of the detected recent learning history (i.e., question code). The learning information database 120 generates a learning information detection completion message including learning information, and transmits it to the learning support module 147.

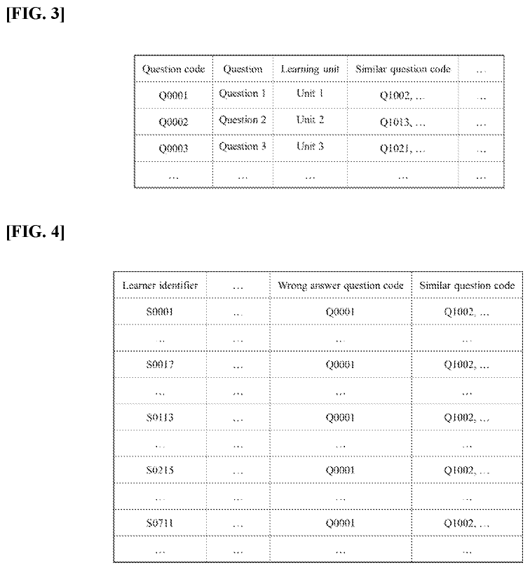

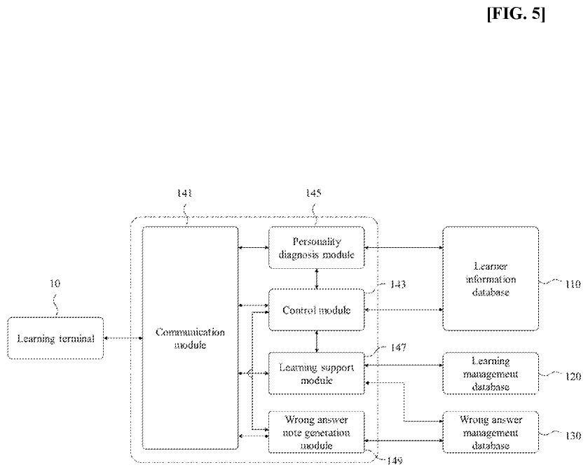

The wrong answer management database 130 stores wrong answer questions of learners in order to provide wrong answer notes to learners. As an example, referring to FIG. 4, the wrong answer management database 130 stores a learner identifier, a wrong answer question code, which is the question code of the question the learner got wrong, a similar question code, which is the question code of the question similar to the question the learner got wrong, and the like, while associating them with each other.

The wrong answer management database 130 detects the learner identifier and question code from the wrong answer storage request query of the learning support module 147 in response to the wrong answer storage request query. The wrong answer management database 130 associates the learner identifier and the question code, and stores them as wrong answer information. After storing the wrong answer information, the wrong answer management database 130 generates a wrong answer storage completion message, and transmits it to the learning support module 147.

The wrong answer management database 130 detects the learner identifier from the wrong answer detection request query in response to the wrong answer detection request query of the wrong answer note generation module 149. The wrong answer management database 130 detects wrong answer information having the same learner identifier as the detected learner identifier from among pre-stored wrong answer information. At this time, the wrong answer management database 130 detects wrong answer information including a learner identifier, a wrong answer question code, a similar question code, and the like. The wrong answer management database 130 generates a wrong answer detection completion message including wrong answer information, and transmits it to the wrong answer note generation module 149.

The learning support server 140 uses data stored in the learner information database 110, the learning information database 120, and the wrong answer management database 130 to provide learners with learning services such as question learning, wrong answer notes, and the like.

The learning support server 140 sets the learner's personality type through the personality diagnosis. The learning support server 140 sets one of openness, conscientiousness, extroversion, agreeableness, and neuroticism as the learner's personality type. To this end, the learning support server 140 provides learners with a plurality of questions composed of animations, and collects learners' responses to the questions. The learning support server 140 assigns a weight to each question, and sets the learner's personality type based on the question and the learner's response. The learning support server 140 calculates propensity values for each personality type, and sets the personality type having the highest propensity value as the personality type of the learner.

The learning support server 140 manages the learning history of a learner learning questions, and provides wrong answer notes to the learner using questions to which the learner gave wrong answers during the learning. The learning support server 140 provides different types of wrong answer notes according to the learner's personality type. In other words, the learning support server 140 does not provide the same form of wrong answer notes to all learners, but provides wrong answer notes configured in different forms to learners with different personality types.

Referring to FIG. 5, the learning support server 140 includes a communication module 141, a control module 143, a personality diagnosis module 145, a learning support module 147, and a wrong answer note generation module 149.

The communication module 141 is configured to transmit/receive learning related data to/from the learning terminal 10 which uses the learning support server 140. Hereinafter, when the control module 143, the personality diagnosis module 145, the learning support module 147, and the wrong answer note generation module 149 are described as transmitting and receiving data to and from the learning terminal 10, it is assumed that this is done through the communication module 141 if there is no special limitation.

The control module 143 determines whether the learner's login is approved in response to the login request information of the learning terminal 10. The control module 143 detects the ID and password from the login request information. The control module 143 generates a learner authentication query including the ID. The control module 143 transmits the learner authentication query to the learner information database 110.

The control module 143 receives authentication information from the learner information database 110 in response to the learner authentication query. The control module 143 compares the password included in the authentication information with the password detected from the login request information to determine whether to approve the login. The control module 143 determines that the login is approved if the two passwords are the same.

The control module 143 determines whether the personality type of the learner is diagnosed if it is determined that the login is approved.

The control module 143 determines that login is approved, and then detects the learner identifier from the authentication information. The control module 143 generates a personality type query including the learner identifier, and transmits it to the learner information database 110.

The control module 143 receives personality type information from the learner information database 110 in response to the personality type query. The control module 143 detects a personality type from personality type information.

If the detected personality type is ‘Null’, the control module 143 generates a personality type setting request including a learner identifier. The control module 143 transmits a personality type setting request to the personality diagnosis module 145.

When the control module 143 receives a personality type setting completion message from the learner information database 110 in response to the personality type setting request, the control module 143 generates a learning start request including a learner identifier. The control module 143 transmits the learning start request to the learning support module 147.

Meanwhile, if the detected personality type is one of openness, conscientiousness, extroversion, agreeableness, and neuroticism, the control module 143 does not transmit a personality type setting request, but generates a learning start request including a learner identifier, and transmits it to the learning support module 147.

The control module 143 generates a wrong answer note provision request in response to the wrong answer note request from the learning terminal 10, and transmits it to the wrong answer note generation module 149. The control module 143 detects the learner identifier from the wrong answer note request. The control module 143 generates a wrong answer note provision request including the learner identifier, and transmits it to the wrong answer note generation module 149.

The personality diagnosis module 145 sets the personality type of the learner in response to the personality type setting request of the control module 143. The personality diagnosis module 145 detects the learner identifier from the personality type setting request. The personality diagnosis module 145 generates a personality type diagnosis start request including a link address of a personality type diagnosis page in which questions for personality diagnosis are displayed in an animated form. The personality diagnosis module 145 transmits a personality type diagnosis start request to the learning terminal 10 corresponding to the learner identifier.

The personality diagnosis module 145 diagnoses the learner's personality type based on the BIG 5 personality test, which is highly reliable in modern psychological theory. The Big Five personality traits refer to the five major elements or dimensions of personality traits established through empirical examinations and studies in psychology. There are five factors: neuroticism, extroversion, attraction, conscientiousness, and openness to experience, and it is a model compiled by Costa & McCrae, and its validity has been confirmed in various countries.

However, since the learners conducting the personality test may feel boredom and difficulties in interpreting the test questions, the Likert scale test is conducted with at least 25 questions using animation.

The learning terminal 10 detects the link address of the personality type diagnosis page from the personality type diagnosis start request in response to the personality type diagnosis start request of the personality diagnosis module 145. The learning terminal 10 accesses the personality type diagnosis page through the link address. Accordingly, as shown in FIG. 6, questions for personality type diagnosis are displayed in the form of animations on the learning terminal 10.

The learning terminal 10 receives answers to questions from the learner, and generates question answer information including the inputted answers. The learning terminal 10 transmits the question answer information to the personality diagnosis module 145.

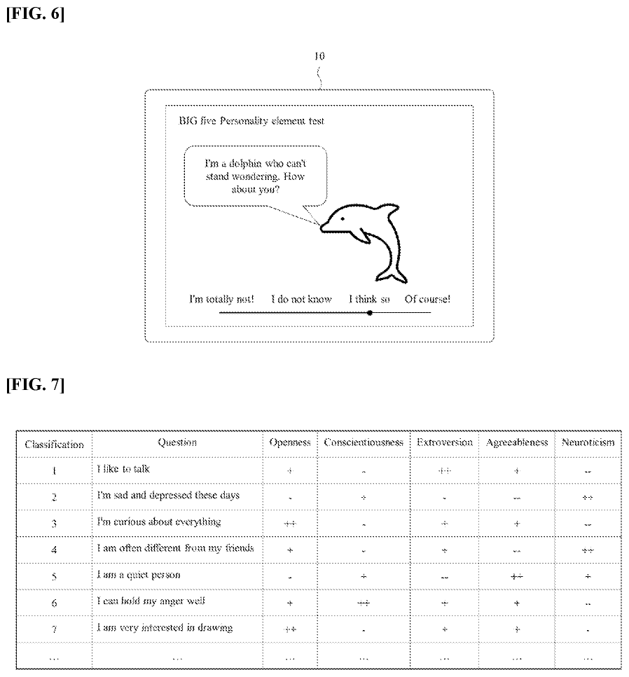

Referring to FIG. 7, the personality diagnosis module 145 sets a personality type in response to question answer information of the learning terminal 10. The personality diagnosis module 145 detects an answer from question answer information. The personality diagnosis module 145 calculates a propensity value for each personality type based on questions and answers. The personality diagnosis module 145 calculates an openness propensity value, a conscientiousness propensity value, an extroversion propensity value, an agreeableness propensity value, and a neuroticism propensity value based on the questions and answers. At this time, a weight for each propensity may be assigned to the question, and a propensity value to which the weight for each propensity is assigned may be calculated.

The personality diagnosis module 145 detects a personality type having the highest propensity value. The personality diagnosis module 145 generates a personality type storage request query, which includes the learner identifier detected from the personality type setting request, and the detected personality type. The personality diagnosis module 145 transmits a personality type storage request query to the learner information database 110.

Meanwhile, the personality diagnosis module 145 selects a personality type having the highest propensity value from among the personality types of the learner according to the weighted and calculated test result, and sets it as the personality type of the learner. Through this, the personality diagnosis module 145 may classify the learner's personality, and set a character that has these characteristics or can interact appropriately. The character represented by each personality trait stimulates learners' learning desire or awakens their concentration by providing dialogues tailored to the learner's personality type on the wrong answer note.

The learning support module 147 provides a learning service to the learning terminal 10 in response to the learning start request of the control module 143.

The learning support module 147 detects a learner identifier from the learning start request in response to the learning start request of the control module 143. The learning support module 147 generates a learning information detection query including the learner identifier. The learning support module 147 transmits the learning information detection query to the learning information database 120.

The learning support module 147 transmits learning information to the learning terminal 10 when receiving a learning information detection completion message that is a response to a learning information detection query from the learning information database 120. At this time, as an example, the learning support module 147 transmits an address link of a learning page including learning information to the learning terminal 10.

The learning terminal 10 accesses the learning information address link of the learning support module 147, and displays the learning page. The learning terminal 10 receives a selection answer for the learning information displayed on the learning page from the learner, and transmits a learning confirmation request including the learner identifier, the question code, and the selected answer to the learning support module 147.

The learning support module 147 determines whether it is a wrong answer in response to the learning confirmation request of the learning terminal 10. That is, the learning support module 147 detects the learner identifier, the question code, and the selected answer from the learning confirmation request. The learning support module 147 compares the selected answer and the learning information to determine whether the answer is correct or not.

If it is determined as the correct answer, the learning support module 147 generates a learning history update request query including the learner identifier and the question code. The learning support module 147 transmits a learning history update request query to the learner information database 110. The learning support module 147 provides the next learning information to the learning terminal 10 by repeating the above-described process in response to the learning history update completion message of the learner information database 110.

Meanwhile, if it is determined that the answer is incorrect, the learning support module 147 generates a wrong answer storage request query including the learner identifier and the question code. The learning support module 147 transmits the wrong answer storage request query to the wrong answer management database 130. The learning support module 147 provides the next learning information to the learning terminal 10 by repeating the above-described process in response to the error storage completion message of the wrong answer management database 130.

The wrong answer note generation module 149 provides the wrong answer note to the learning terminal 10 in response to the wrong answer note provision request of the control module 143. The wrong answer note generation module 149 provides various forms of wrong answer notes to the learning terminal 10 according to the learner's personality type.

The wrong answer note generation module 149 detects the learner identifier from the wrong answer note provision request of the control module 143.

The wrong answer note generation module 149 generates a personality type detection request query including the learner identifier. The wrong answer note generation module 149 transmits the personality type detection request query to the learner information database 110. The wrong answer note generation module 149 receives a personality type detection completion message as a response to the personality type detection request query.

The wrong answer note generation module 149 generates a wrong answer detection request query including the learner identifier. The wrong answer note generation module 149 transmits the wrong answer detection request query to the wrong answer management database 130. The wrong answer note generation module 149 receives an error detection completion message as a response to the wrong answer detection request query.

The wrong answer note generation module 149 detects the personality type from the personality type detection completion message, and detects wrong answer information from the wrong answer detection completion message. The wrong answer note generation module 149 generates a wrong answer note by inserting wrong answer information into a form pre-set according to a personality type. At this time, the wrong answer note generation module 149 sets a different type of wrong answer note format for each personality type.

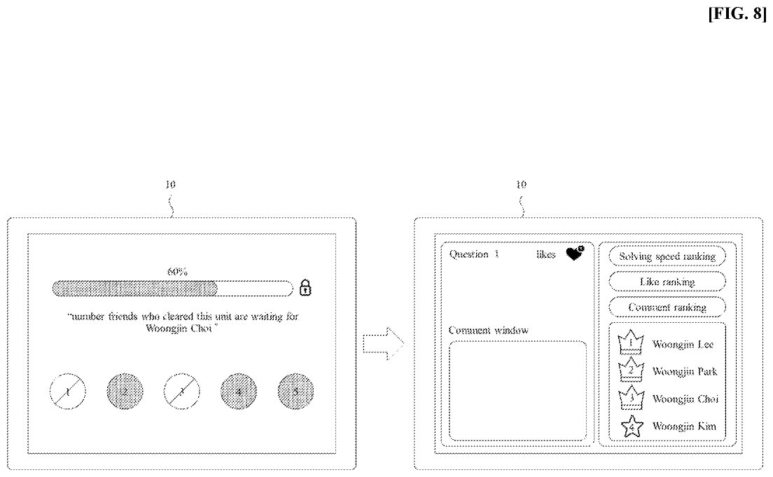

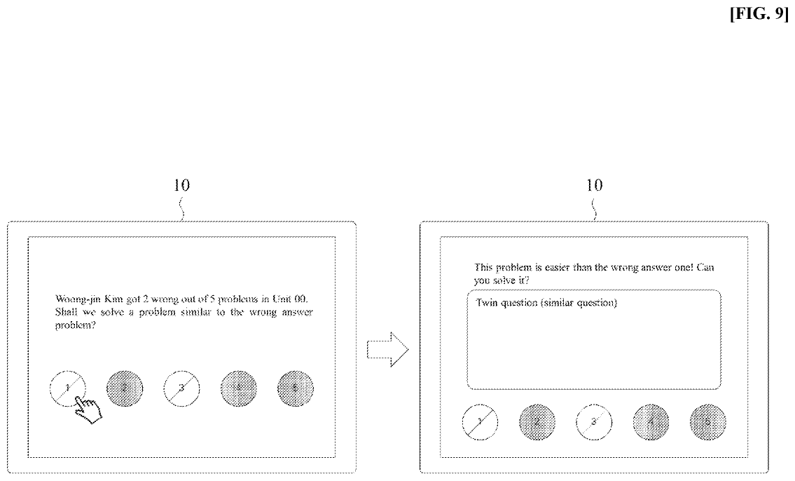

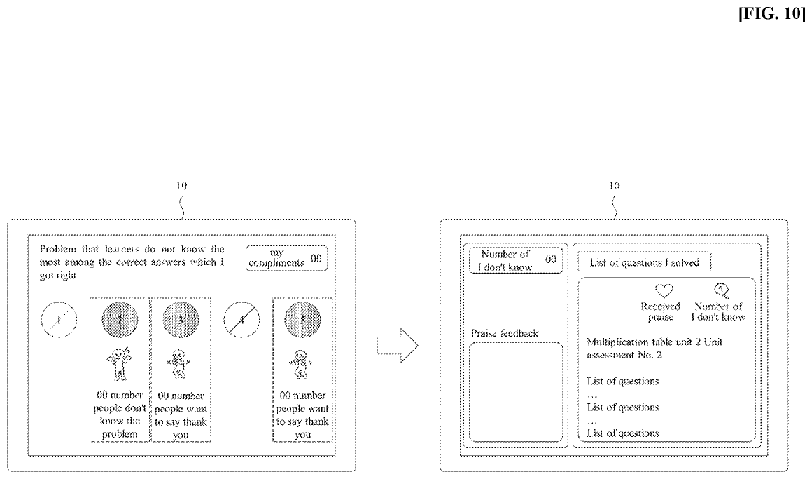

Referring to FIG. 8, if the learner's personality type is extroversion, the wrong answer note generation module 149 generates the wrong answer note through bulletin boards and rankings so that the extroversion learner can actively take action through the discussions with friends. Extraversion is the degree to which a person desires interaction with others and seeks attention from others, which consists of warmheartedness, sociability, leadership, positiveness, and positivity. Learners with high levels of these components are usually not only sociable, but also lively and talkative, and tend to prefer excitement and stimulation with assertiveness and occasional high energy. Accordingly, the wrong answer note generation module 149 stimulates the learner through a progress bar so that the learner can solve all the corresponding units, and provides a wrong answer note including a bulletin board through which solutions can be shared with other learners, and a ranking system capable of stimulating the desire for winning.

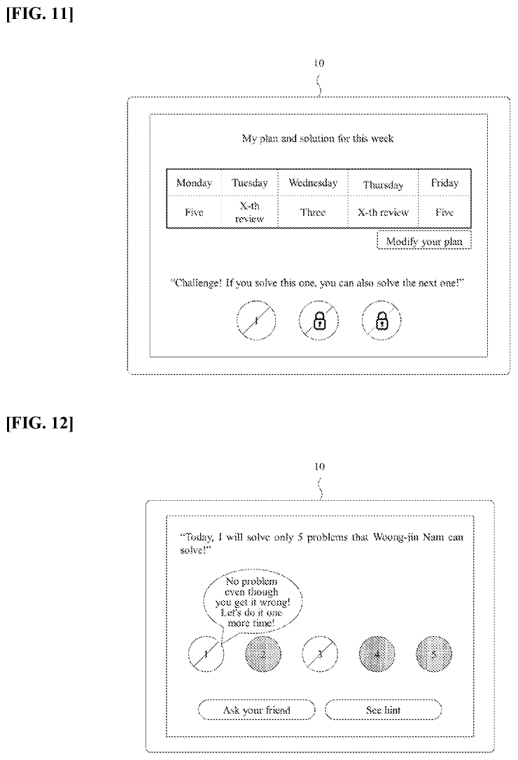

Referring to FIG. 9, if the personality type of the learner is openness, the wrong answer note generation module 149 generates a wrong answer note including similar questions of the same type as the wrong answer question. Openness is a personality type characterized in that a person of this personality quickly gets bored with work, action, learning, and the like. This is the degree of openness to the world one experiences, interest in, curiosity about the world around oneself, and the pursuit and tolerance of various experiences, and the pursuit and tolerance of various experiences, and such people are highly imaginative, cultural, emotional, experience-seeking, and intellectually curious. Learners of this openness like various experiences, and tend to receive and accept new things rather than rules or conventions. Accordingly, the wrong answer note generation module 149 stimulates curiosity by first presenting similar questions (i.e., twin questions) that are similar in concept to the question the learner failed but have a lower level of difficulty. The wrong answer note generation module 149 presents incorrectly answered questions after the learner completes solving the similar questions.

Referring to FIG. 10, if the learner's personality type is attraction (i.e., agreeableness), the wrong answer note generation module 149 generates a wrong answer note in which incorrectly answered questions of other learners and correctly answered questions of the learner are associated. Attraction (agreeableness) indicates the degree to which a person maintains a comfortable and harmonious relationship with others. People with high attraction are considerate of others first, empathize well, and help well. As a result, they think that the other person will help them well, and they feel a great motivation to be praised. A learner of attraction, for whom praise is important, may help other learners and receive praise by presenting the number of ‘I don't know’ button hits of other learners. Praise allows learners who pressed the ‘I don't know’ button to press buttons expressing gratitude after seeing the attraction learner's solution and correct answer. Among the learner's correct answers, presenting the question that other learners do not know the most, and asking it again leads to an opportunity to help others and to allow the character to give a grateful feedback. After this, checking the praise to the questions which the learner solved by himself/herself stimulates the learning motivation.

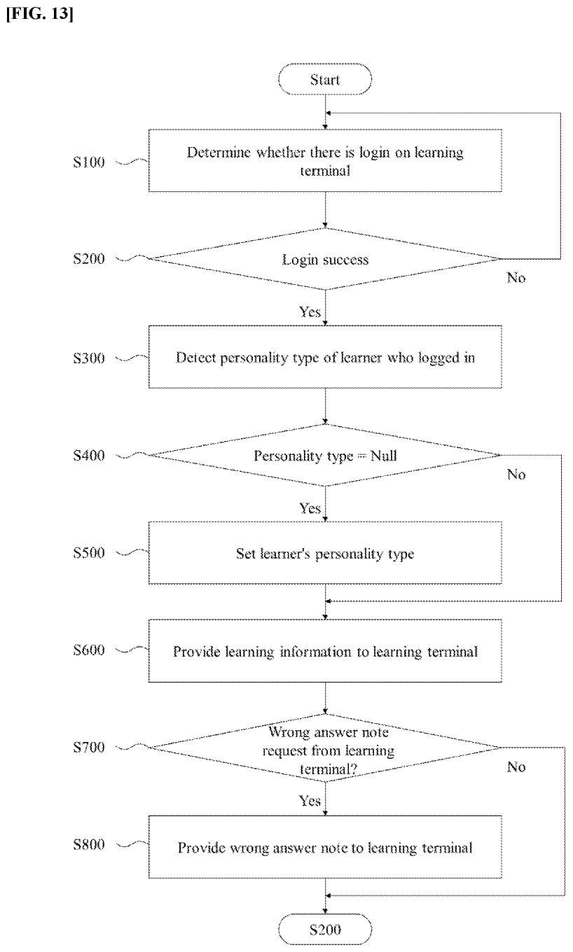

Referring to FIG. 11, if the learner's personality type is conscientiousness, the wrong answer note generation module 149 sequentially presents a plurality of incorrectly answered questions according to difficulty level, and generates a wrong answer note configured to allow the learner to make a plan through a calendar. Conscientiousness is the degree to which one is willing to abide by social rules, norms, and principles, and is composed of competence, organizational ability, responsibility, goal orientation, self-control, and perfection. Learners with high conscientiousness tend to be accurate and meticulous in everything, so they do not just set goals and think, but practice them well, have a strong will, and are easy to learn with self-directedness. However, they may be sensitive and perfect in relation to academic and professional achievements, so they may not be able to look around. Therefore, learners with high conscientiousness are most optimized for the existing wrong answer notes, but the wrong answer note generation module 149 sequentially presents questions from easy to difficult according to the difficulty of the question, and provides a calendar so that they can make a plan, thereby maximizing the satisfaction of learning.

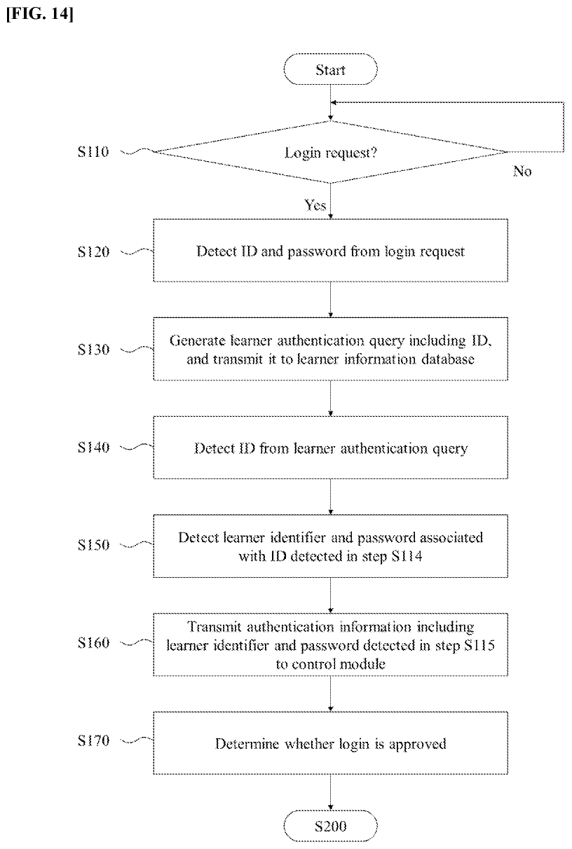

Referring to FIG. 12, if the personality type of the learner is neuroticism, the wrong answer note generation module 149 generates a wrong answer note including a preset number of wrong answer questions in increasing order of their difficulties. Neuroticism is an emotional stability that measures the degree of emotional instability, and is the degree to which one has control over the world and regards it as nonthreatening, and is composed of anxiety, anger, depression, self-consciousness, impulsivity, and vulnerability to stress. Learners with high levels of neuroticism are prone to stress, and have difficulty controlling their needs. If this part gets worse, the learners may experience problems in mental and psychological parts. Therefore, the wrong answer note generation module 149 provides only 5 questions in the order of lowest difficulty among wrong answer questions per day to reduce the experience of failure and to experience success, and allows the learner to freely view solutions of friends. At this time, the wrong answer note generation module 149 associates the neuroticism learner with the attraction learner's question solution through ‘ask a friend’ to exert synergy. The wrong answer note generation module 149 constructs a wrong answer note so that only a part of the representative solution of the extroversion learners' ranking board is visible for learners who want to solve the question through a hint rather than a correct answer. The wrong answer note generation module 149 replaces negative marks such as red color with green color to provide psychological stability, and provides feedback through the character that it is okay even if it is wrong.

Hereinafter, a method for supporting study based on personality type according to personality type in accordance with an embodiment of the present disclosure will be described with reference to the accompanying drawings.

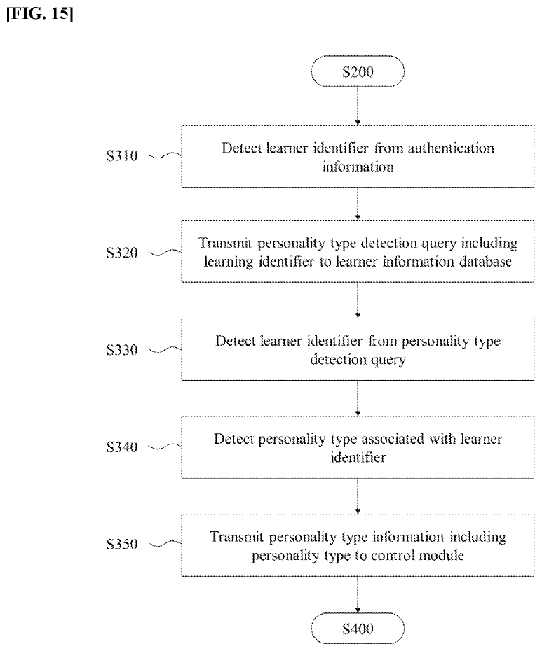

Referring to FIG. 13, the system for supporting study based on personality type 100 determines whether or not the login of the learning terminal 10 is approved (S100).

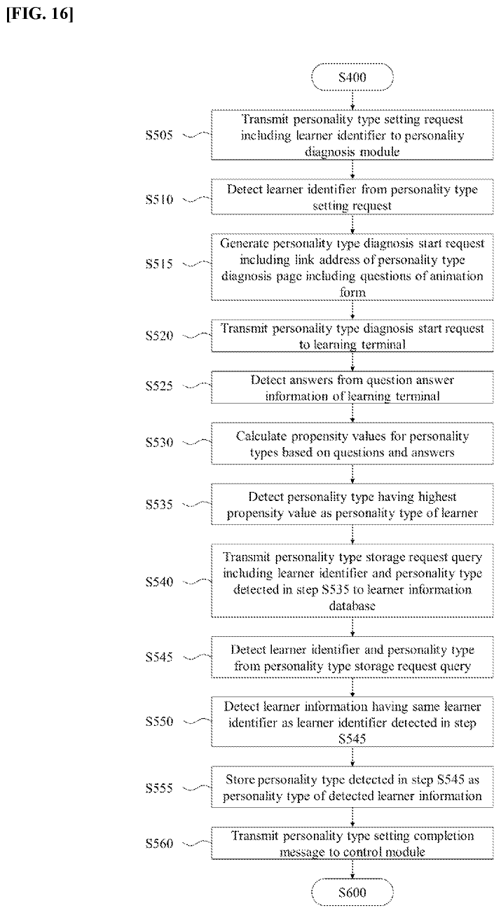

Referring to FIG. 14, upon receiving a login request from the learning terminal 10 (S110; Yes), the control module 143 detects an ID and password from the login request (S120).

The control module 143 generates a learner authentication query including the ID, and transmits it to the learner information database 110 (S130).

The learner information database 110 detects an ID from the learner authentication query of the control module 143 in response to the learner authentication query (S140).

The learner information database 110 detects a learner identifier and password associated with the detected ID (S150).

The learner information database 110 generates authentication information including the learner identifier and password detected in response to the learner authentication query, and transmits it to the control module 143 (S160).

The control module 143, which has received authentication information from the learner information database 110 in response to the learner authentication query, compares the password included in the authentication information with the password detected from the login request information to determine whether to approve the login (S170). The control module 143 determines that the login is approved if the two passwords are the same.

If it is determined that the login is successful (S200; Yes), the system for supporting study based on personality type 100 detects the personality type of the learner logged in to the system for supporting study based on personality type 100 (S300).

Referring to FIG. 15, the control module 143 detects a learner identifier from authentication information (S310).

The control module 143 generates a personality type query including the learner identifier, and transmits it to the learner information database 110 (S320).

The learner information database 110 detects the learner identifier from the personality type query of the control module 143 in response to the personality type query (S330).

The learner information database 110 detects a personality type associated with the detected learner identifier (S340).

The learner information database 110 generates personality type information including the detected personality type in response to the personality type query, and transmits it to the control module 143 (S350). At this time, if there is no personality type associated with the learner identifier, the learner information database 110 generates personality type information including ‘Null’ and transmits it to the control module 143.

If the personality type detected through step S300 is ‘Null’ (S400; Yes), the system for supporting study based on personality type 100 sets the personality type of the learner (S500).

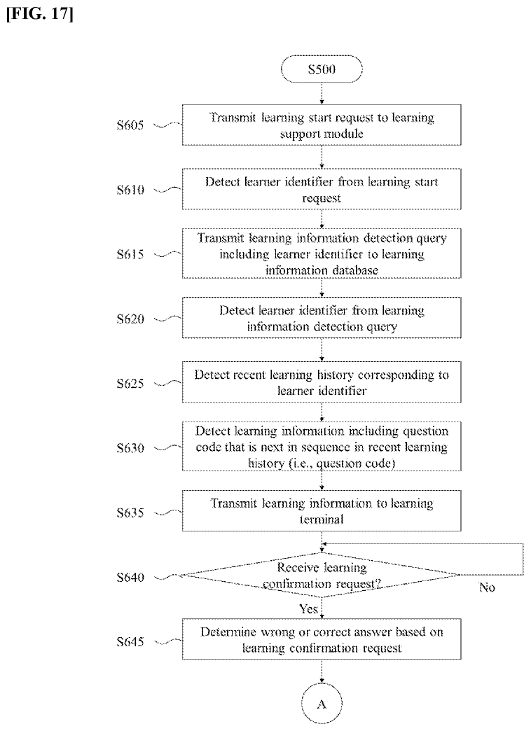

Referring to FIG. 16, the control module 143 generates a personality type setting request including the learner identifier, and transmits it to the personality diagnosis module 145 (S505).

The personality diagnosis module 145 detects a learner identifier from the personality type setting request in response to the personality type setting request of the control module 143 (S510).

The personality diagnosis module 145 generates a personality type diagnosis start request including a link address of a personality type diagnosis page in which questions for personality diagnosis are displayed in an animated form (S515).

The personality diagnosis module 145 transmits a personality type diagnosis start request to the learning terminal 10 corresponding to the learner identifier (S520). The learning terminal 10 detects the link address of the personality type diagnosis page from the personality type diagnosis start request in response to the personality type diagnosis start request of the personality diagnosis module 145. The learning terminal 10 accesses the personality type diagnosis page through the link address. The questions for personality type diagnosis are displayed in the form of animations on the learning terminal 10. The learning terminal 10 receives answers to questions from the learner, and generates question answer information including the inputted answers. The learning terminal 10 transmits the question answer information to the personality diagnosis module 145.

The personality diagnosis module 145 detects an answer from the question answer information of the learning terminal 10 (S525).

The personality diagnosis module 145 calculates a propensity value for each personality type based on questions and answers (S530). The personality diagnosis module 145 calculates an openness propensity value, a conscientiousness propensity value, an extroversion propensity value, an agreeableness propensity value, and a neuroticism propensity value based on the questions and answers. At this time, a weight for each propensity may be assigned to the question, and a propensity value to which the weight for each propensity is assigned may be calculated.

The personality diagnosis module 145 detects the personality type having the highest propensity value as the personality type of the learner (S535).

The personality diagnosis module 145 generates a personality type storage request query, which includes the learner identifier detected from the personality type setting request and the personality type detected at step S535, and transmits it to the learner information database 110 (S540).

The learner information database 110 detects the learner identifier and personality type from the personality type storage request query of the personality diagnosis module 145 in response to the personality type storage request query (S545).

The learner information database 110 detects learner information having the same learner identifier as the detected learner identifier from among pre-stored learner information (S550).

The learner information database 110 stores the personality type detected from the personality type storage request query as the personality type of the detected learner information (S555).

After completing the storage of the personality type, the learner information database 110 generates a personality type setting completion message and transmits it to the control module 143 (S560).

When the personality type is set or has already been set, the system for supporting study based on personality type 100 provides learning information to the learning terminal 10 (S600).

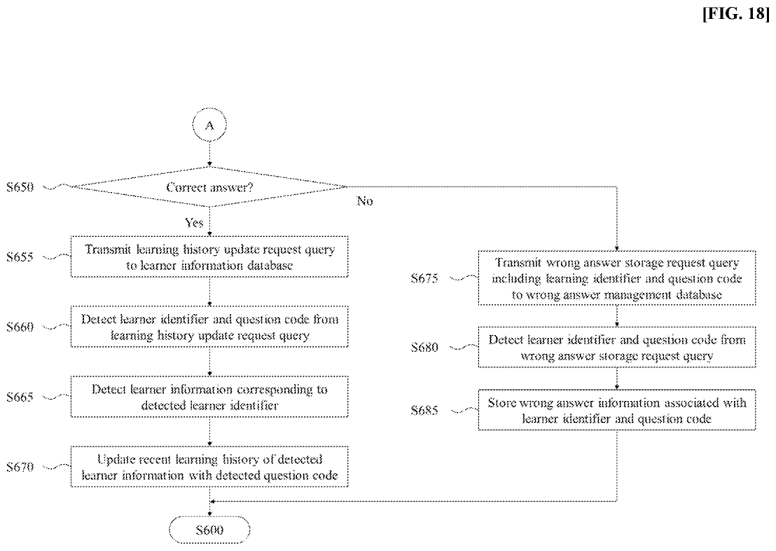

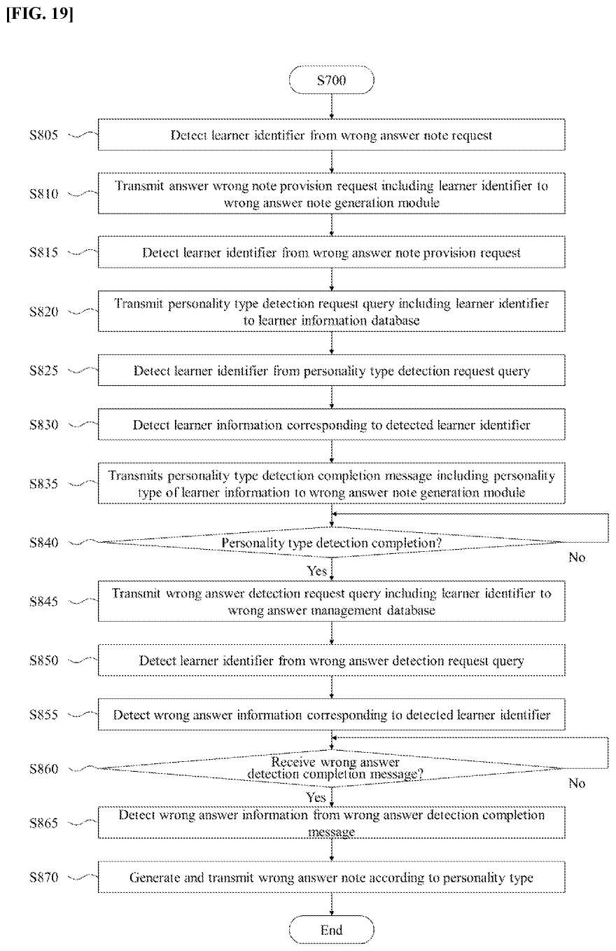

FIGS. 17 and 18, the control module 143 generates a learning start request including a learner identifier, and transmits it to the learning support module 147 (S605).

The learning support module 147 detects a learner identifier from the learning start request in response to the learning start request of the control module 143 (S610).

The learning support module 147 generates a learning information detection query including the learner identifier, and transmits it to the learning information database 120 (S615).

The learning information database 120 detects a learner identifier from the learning information detection query in response to the learning information detection query of the learning support module 147 (S620).

The learning information database 120 detects a recent learning history corresponding to the detected learner identifier from the learner information database 110 (S625).

The learning information database 120 detects learning information including the question code that is the next sequence of the detected recent learning history (i.e., question code) (S630). The learning information database 120 generates a learning information detection completion message including learning information, and transmits it to the learning support module 147.

The learning support module 147, which has received the learning information detection completion message as a response to the learning information detection query from the learning information database 120, transmits the learning information to the learning terminal 10 (S635). At this time, as an example, the learning support module 147 transmits an address link of a learning page including learning information to the learning terminal 10.

The learning terminal 10 accesses the learning information address link of the learning support module 147, and displays the learning page. The learning terminal 10 receives a selection answer for the learning information displayed on the learning page from the learner, and transmits a learning confirmation request including the learner identifier, the question code, and the selected answer to the learning support module 147. When a learning confirmation request is received from the learning terminal 10 (S640; Yes), the learning support module 147 determines whether or not an answer is correct based on the learning confirmation request (S645). The learning support module 147 detects the learner identifier, the question code, and the selected answer from the learning confirmation request. The learning support module 147 compares the selected answer and the learning information to determine whether the answer is correct or not.

If it is determined as a correct answer (S650; Yes), the learning support module 147 generates a learning history update request query including the learner identifier and the question code, and transmits it to the learner information database 110 (S655).

The learner information database 110 detects the learner identifier and question code from the learning history update request query of the learning support module 147 in response to the learning history update request query (S660).

The learner information database 110 detects learner information having the same learner identifier as the detected learner identifier from among pre-stored learner information (S665).

After updating the latest learning history of the detected learner information with the question code detected from the learning history update request query, the learner information database 110 generates a learning history update completion message, and transmits it to the learning support module 147 (S670).

Meanwhile, if it is determined as a wrong answer, the learning support module 147 generates a wrong answer storage request query including the learner identifier and the question code, and transmits it to the wrong answer management database 130 (S675).

The wrong answer management database 130 detects the learner identifier and question code from the wrong answer storage request query of the learning support module 147 in response to the wrong answer storage request query (S680).

The wrong answer management database 130 associates the learner identifier and the question code, and stores them as wrong answer information, and then generates a wrong answer storage completion message, and transmits it to the learning support module 147 (S685).

The learning support module 147 provides the next learning information to the learning terminal 10 by repeating the above-described process when receiving the learning history update completion message or the wrong answer storage completion message.

When receiving the wrong answer note request from the learning terminal 10 during learning (S700; Yes), the system for supporting study based on personality type 100 provides the learner's wrong answer note to the learning terminal 10 (S800). At this time, the system for supporting study based on personality type 100 provides various forms of wrong answer notes to the learning terminals 10 according to the personality types of the learners.

Referring to FIG. 19, the control module 143 detects a learner identifier from the wrong answer note request of the learning terminal 10 (S805).

The control module 143 generates a wrong answer note provision request including the learner identifier, and transmits it to the wrong answer note generation module 149 (S810).

The wrong answer note generation module 149 detects the learner identifier from the wrong answer note provision request of the control module 143 (S815).

The wrong answer note generation module 149 generates a personality type detection request query including the learner identifier, and transmits it to the learner information database 110 (S820).

The learner information database 110 detects the learner identifier from the personality type detection request query in response to the personality type detection request query of the wrong answer note generation module 149 (S825).

The learner information database 110 detects learner information having the same learner identifier as the detected learner identifier from among pre-stored learner information (S830).

The learner information database 110 detects the personality type of the detected learner information, generates the personality type detection completion message including the detected personality type, and transmits it to the wrong answer note generation module 149 (S835).

When receiving the personality type detection completion message (S840; Yes), the wrong answer note generation module 149 generates the wrong answer detection request query including the learner identifier, and transmits it to the wrong answer management database 130 (S845).

The wrong answer management database 130 detects the learner identifier from the wrong answer detection request query in response to the wrong answer detection request query of the wrong answer note generation module 149 (S850).

The wrong answer management database 130 detects wrong answer information having the same learner identifier as the detected learner identifier from among pre-stored wrong answer information (S855). At this time, the wrong answer management database 130 detects wrong answer information including a learner identifier, a wrong answer question code, a similar question code, and the like.

The wrong answer management database 130 generates a wrong answer detection completion message including wrong answer information, and transmits it to the wrong answer note generation module 149. When receiving the wrong answer detection completion message (S860; Yes), the wrong answer note generation module 149 detects the personality type from the personality type detection completion message, and detects wrong answer information from the wrong answer detection completion message (S865).

The wrong answer note generation module 149 generates a wrong answer note by inserting wrong answer information into a form pre-set according to a personality type, and transmits it to the learning terminal 10 (S870). At this time, the wrong answer note generation module 149 sets a different type of wrong answer note format for each personality type.

If the personality type of the learner is extroversion, the wrong answer note generation module 149 generates wrong answer notes through bulletin boards and rankings so that the extroversion learner can actively take action through the discussions with friends. That is, the wrong answer note generation module 149 stimulates the learner through a progress bar so that the learner can solve all the corresponding units, and provides a wrong answer note including a bulletin board through which solutions can be shared with other learners, and a ranking system capable of stimulating the desire for winning.

If the personality type of the learner is openness, the wrong answer note generation module 149 generates a wrong answer note including similar questions of the same type as the wrong answer question. That is, the wrong answer note generation module 149 stimulates curiosity by first presenting similar questions (i.e., twin questions) which are similar in concept to but low in difficulty to the question the learner got wrong, and the wrong answer note generation module presents the wrong answer question after the learner completes solving the similar questions.

If the learner's personality type is attraction (i.e., agreeableness), the wrong answer note generation module 149 generates a wrong answer note in which incorrectly answered questions of other learners and correctly answered questions of the learner are associated.

If the learner's personality type is conscientiousness, the wrong answer note generation module 149 sequentially presents a plurality of incorrectly answered questions according to difficulty level, and generates a wrong answer note configured to allow the learner to make a plan through a calendar.

If the personality type of the learner is neuroticism, the wrong answer note generation module 149 generates a wrong answer note including a preset number of wrong answer questions in increasing order of their difficulties. The wrong answer note generation module 149 provides only 5 questions in the order of lowest difficulty among wrong answer questions per day to reduce the experience of failure and to experience success, and allows the learner to freely view solutions of friends. At this time, the wrong answer note generation module 149 generates the wrong answer note that can be associated with the attraction learner and the extroversion learner.

The above description is merely illustrative of the technical idea of the present disclosure, and various modifications and changes can be made by those of ordinary skill in the art to which the present disclosure pertains, without departing from the essential characteristics of the present disclosure. Accordingly, the embodiments disclosed in the present disclosure are not for limiting, but for explaining the technical spirit of the present disclosure, and the scope of the technical idea of the present disclosure is not limited by these embodiments. The protection scope of the present disclosure should be construed by the following claims, and all technical ideas within the scope equivalent thereto should be construed as being included in the scope of the present disclosure.

[Description of reference numerals]

| | |
|---|---|
| 100: System for supporting | |
| study based on personality type | |
| 110: learner information database | |
| 120: Learning information database | 130: Wrong answer management |
| | database |
| 140: Learning support server | 141: Communication module |
| 143: Control module | 145: Personality diagnosis module |
| 147: Learning support module | 149: Wrong answer note generation |
| | module |

1. A system for supporting study based on personality type comprising:
a learning support server connected with a learning terminal through a network,
wherein the learning support server includes:
a control module which outputs a personality type query including a learner identifier of the learning terminal, which, if personality type information received as a response to the personality type query is ‘Null’, outputs a personality type setting request including the learner identifier, which, when a personality type setting completion message is received in response to the personality type setting request, outputs a learning start request including the learner identifier, and which outputs a wrong answer note provision request including the learner identifier in response to a wrong answer note request from the learning terminal;
a personality diagnosis module which transmits a personality type diagnosis start request to the learning terminal in response to a personality type setting request of the control module, which calculates a propensity value for each personality type based on question and response information of the learning terminal, that is a response to the personality type diagnosis start request, and which sets the personality type of the learner based on the propensity value for each personality type;
a learning support module which outputs a learning information detection query including the learner identifier in response to a learning start request from the control module, which transmits learning information included in a learning information detection completion message, that is a response to the learning information detection query, to the learning terminal, and which outputs a wrong answer storage request query including a question code of a question determined to be a wrong answer and the learner identifier in response to a learning confirmation request of the learning terminal; and
a wrong answer note generation module which outputs a wrong answer detection request query and a personality type detection request query including the learner identifier in response to a wrong answer note provision request of the control module, which detects a personality type from a personality type detection completion message that is a response to the personality type detection request query, which detects wrong answer information from a wrong answer detection completion message that is a response to the wrong answer detection request query, and which transmits to the learning terminal a wrong answer note in which the wrong answer information is inserted into a wrong answer note form corresponding to the personality type.

2. The system for supporting study based on personality type of claim 1, wherein the personality diagnosis module transmits to the learning terminal a personality type diagnosis start request including a link address of a personality type diagnosis page in which questions for personality diagnosis are displayed in animations.

3. The system for supporting study based on personality type of claim 1, wherein the personality diagnosis module calculates an openness propensity value, a conscientiousness propensity value, an extroversion propensity value, an agreeableness propensity value, and a neuroticism propensity value, and detects the personality type having the highest propensity value as a personality type of the learner.

4. The system for supporting study based on personality type of claim 1, wherein the personality diagnosis module sets weights for each personality type to questions for personality diagnosis, and calculates a propensity value for each personality type reflecting the weight for each personality type.

5. The system for supporting study based on personality type of claim 1, wherein the wrong answer note generation module generates different types of wrong answer notes according to personality types.

6. The system for supporting study based on personality type of claim 5, wherein the wrong answer note generation module is configured to:
when the personality type of the learner is openness, generate a wrong answer note including a wrong answer question and a similar question having a difficulty lower than that of the wrong answer question among similar questions of the wrong answer question;
when the personality type of the learner is agreeableness, generate a wrong answer note associating the wrong answer questions of other learners and the correct answer questions of the learner;
when the personality type of the learner is conscientiousness, sequentially present a plurality of wrong answer questions according to difficulty level, and generate a wrong answer note configured to allow the learner to make a plan through a calendar; and
when the personality type of the learner is neuroticism, generate a wrong answer note including a preset number of wrong answer questions in increasing order of their difficulties.

7. The system for supporting study based on personality type of claim 1, further comprising a learner information database which stores a learner identifier, a recent learning history, and a personality type of a learner while associating them with each other,
wherein the learner information database is configured to:
detect a personality type associated with a learner identifier detected from the personality type query in response to a personality type query of the control module, and transmit personality type information including the personality type to the control module; and
detect a personality type associated with a learner identifier detected from the personality type query in response to a personality type detection request query of the wrong answer note generation module, and transmit a personality type detection completion message including the detected personality type to the wrong answer note generation module.

8. The system for supporting study based on personality type of claim 1, further comprising a wrong answer management database which stores a learner identifier, a wrong answer question code, and a similar question code while associating them with each other,
wherein the wrong answer management database is configured to:
detect a learner identifier and a question code from the wrong answer storage request query of the learning support module in response to the wrong answer storage request query, and store wrong answer information associating the learner identifier and the question code; and
detect wrong answer information having the same learner identifier as the learner identifier detected from the wrong answer detection request query in response to the wrong answer detection request query of the wrong answer note generation module, and transmit a wrong answer detection completion message including detected wrong answer information to the wrong answer note generation module.

9. A method for supporting study based on personality type performed by a system for supporting study based on personality type connected with a learning terminal through a network, the method for supporting study based on personality type comprising:
determining whether to approve a login of a learner accessing through the learning terminal;
detecting a personality type of the learner if it is determined that the login is approved in the determining;
setting a personality type of the learner if the personality type of the learner is ‘Null’ in the detecting;
transmitting learning information to the learning terminal when the personality type of the learner is detected in the detecting or the personality type is set in the setting the personality type; and
transmitting a wrong answer note generated in a form corresponding to the personality type of the learner to the learning terminal when receiving a wrong answer note provision request from the learning terminal after the transmitting the learning information.

10. The method for supporting study based on personality type of claim 9, wherein the setting the personality type includes:
detecting, by a personality diagnosis module, a learner identifier of a learner to whom a personality type is to be set;
generating, by the personality diagnosis module, a personality type diagnosis start request including a link address of a personality type diagnosis page in which questions for personality diagnosis are displayed in animations;
transmitting, by the personality diagnosis module, the personality type diagnosis start request to a learning terminal;
receiving, by the personality diagnosis module, question answer information as a response to the personality type diagnosis start request from the learning terminal, and detecting an answer from the question answer information;
calculating, by the personality diagnosis module, a propensity value for each personality type based on the questions and answers;
detecting, by the personality diagnosis module, as a personality type of the learner, a personality type having the highest propensity value among the propensity values for each personality type calculated in the calculating the propensity value for each personality type; and
generating, by the personality diagnosis module, a personality type storage request query including the learner identifier detected in the detecting the learner identifier and the personality type detected in the detecting as the personality type, and transmitting the personality type storage request query to a learner information database.

11. The method for supporting study based on personality type of claim 10, wherein in the calculating the propensity values for each personality type, an openness propensity value, a conscientiousness propensity value, an extroversion propensity value, an agreeableness propensity value, and a neuroticism propensity value are calculated.

12. The method for supporting study based on personality type of claim 10, wherein in the calculating the propensity value for each personality type, weights for each personality type to questions for personality diagnosis are set, and a propensity value for each personality type reflecting the weight for each personality type is calculated.

13. The method for supporting study based on personality type of claim 9, wherein the transmitting the incorrect answer note further includes:
detecting, by a wrong answer note generation module, a learner identifier from a wrong answer note request of the learning terminal;
transmitting, by the incorrect answer note generation module, a personality type detection request query including the learner identifier;
detecting, by the incorrect answer note generating module, a personality type from a personality type detection completion message that is a response to the personality type detection request query;
transmitting, by the incorrect answer note generation module, a wrong answer detection request query including the learner identifier after receiving the personality type detection completion message;
detecting, by the incorrect answer note generation module, incorrect answer information from an incorrect answer detection complete message that is a response to the incorrect answer detection request query;
generating, by the incorrect answer note generating module, an incorrect answer note in which the wrong answer information detected in the detecting the wrong answer information is inserted into an incorrect answer note form corresponding to the personality type detected in the detecting the personality type; and
transmitting, by the wrong answer note generation module, the incorrect answer note to the learning terminal.

14. The method for supporting study based on personality type of claim 13, wherein the transmitting the wrong answer note further includes:
detecting, by a learner information database, a learner identifier from the personality type detection request query in response to the personality type detection request query;
detecting, by the learner information database, learner information having the same learner identifier as the learner identifier; and
detecting, by the learner information database, one personality type from among openness, conscientiousness, extroversion, agreeableness, and neuroticism from the learner information detected in the detecting the learner information, and transmitting a personality type detection completion message including the detected personality type to the wrong answer note generation module.

15. The method for supporting study based on personality type of claim 13, wherein the transmitting the wrong answer note further includes:
detecting, by a wrong answer management database, a learner identifier from the wrong answer detection request query in response to the wrong answer detection request query;
detecting, by the wrong answer management database, wrong answer information having the same learner identifier as the learner identifier, and detecting wrong answer information including a learner identifier, a wrong answer question code, and a similar question code; and
transmitting, by the wrong answer management database, a wrong answer detection completion message including the wrong answer information to the wrong answer note generation module.

16. The method for supporting study based on personality type of claim 13, wherein the generating the inserted wrong answer note includes:
when the personality type of the learner is openness, generating a wrong answer note including a wrong answer question and a similar question having a difficulty lower than that of the wrong answer question among similar questions of the wrong answer question;
when the personality type of the learner is agreeableness, generating a wrong answer note associating the wrong answer questions of other learners and the correct answer questions of the learner;
when the personality type of the learner is conscientiousness, sequentially presenting a plurality of wrong answer questions according to difficulty level, and generating a wrong answer note configured to allow the learner to make a plan through a calendar; and
when the personality type of the learner is neuroticism, generating a wrong answer note including a preset number of wrong answer questions in increasing order of their difficulties.
